(19) United States
(12) Patent Application Publication
(10) Pub. No.: US 2009/0022171 A1
(43) Pub. Date: Jan. 22, 2009

(54) INTERRUPT COALESCING SCHEME FOR HIGH THROUGHPUT TCP OFFLOAD ENGINE

(75) Inventors: XI CHEN, MOUNTAIN VIEW, CA (US); XIAOCHONG CAO, MOUNTAIN VIEW, CA (US); YUNG-CHUNG LIU, MOUNTAIN VIEW, CA (US); CHIEN-HSIUNG CHANG, MOUNTAIN VIEW, CA (US); CHIH-HSIEN HSU, MOUNTAIN VIEW, CA (US)

Correspondence Address: ROSENBERG, KLEIN & LEE, 3458 ELLICOTT CENTER DRIVE-SUITE 101, ELLICOTT CITY, MD, 21043, US

(73) Assignee: STORLINK SEMICONDUCTORS, INC., MOUNTAIN VIEW, CA (US)

(21) Appl. No.: 11/780,063

(22) Filed: Jul. 19, 2007

(51) Int. Cl. H04L 12/56

(52) U.S. Cl. 370/412

(57) ABSTRACT

An interrupt coalescing scheme for high throughput TCP offload engine and method thereof are disclosed. An interrupt descriptor queue is used, that TCP offload engine saves TCP connection information and interrupt information in an interrupt event descriptor per interrupt. Meanwhile the software processes an interrupt by reading interrupt event descriptors asynchronously. The software may process multiple interrupt event descriptors in one interrupt context.

### BACKGROUND OF THE INVENTION

1. Field of the Invention

The present invention relates to an interrupt coalescing scheme, more specially, to an interrupt coalescing scheme for high throughput TCP offload engine and method thereof.

2. Description of the Prior Art

The computer performance has increased in recent years, causing the demands on computer networks increased significantly; faster computer processors and higher memory capabilities drive the needs for networks with high bandwidth capabilities to enable high speed transfer of significant amounts of data.

The communication speed in networking systems has surpassed the growth of microprocessor performance in many network devices. For example, Ethernet has become the most commonly used networking protocol for local area networks. The increase in speed from 10 Mb/s Ethernet to 10 Gb/s Ethernet has not been matched by a commensurate increase in the performance of processors used in most network devices.

As speed has increased, design constraints and requirements have become more and more complex with respect to following appropriate design and protocol rules and providing a low cost, commercially viable solution. This phenomenon has produced an input/output (I/O) bottleneck because network device processors cannot always keep up with the rate of data flow through a network. An important reason for the bottleneck is that the TCP/IP stack is processed at a rate slower than the speed of the network. The processing of TCP/IP has typically been performed by software running on a central processor of a server. Reassembling out-of-order packets, processing interrupts and performing memory copies places a significant load on the CPU. In high-speed networks, such a CPU may need more processing capability for network traffic than for running other applications.

A TCP/IP offload engine (TOE) helps to relieve this I/O bottleneck by removing the burden (offloading) of processing TCP/IP from the microprocessor(s) and I/O subsystem. A TCP/IP offload engine has typically been implemented in a host bus adapter (“HBA”) or a network interface card (“NIC”).

If TOE throughput cannot be sufficiently increased simply by increasing processor clock speeds, then other techniques will have to be employed if the desired increased throughput is to be achieved. One technique for increasing throughput involves increasing the width of the processor's data bus and using a wider data bus and ALU. Although this might increase the rate at which certain TCP/IP offload engine functions are performed, the execution of other functions will still likely be undesirably slow due to the sequential processing nature of the other TCP/IP offload tasks. Other computer architecture techniques that might be employed involve using a multi-threaded processor and/or pipelining in an attempt to increase the number of instructions executed per unit time, but again clock rates can be limiting. It is envisioned that supporting the next generation of high-speed networks will require pushing the clock speeds of even the most state-of-the-art processors beyond available rates. Even if employing such an advanced and expensive processor on a TCP/IP offload engine were possible, employing such a processor would likely be unrealistically complex and economically impractical.

### SUMMARY OF THE INVENTION

In view of the above problems associated with the related art, it is an object of the present invention to provide an interrupt coalescing scheme for high throughput TCP offload engine. An interrupt descriptor queue is used to store the information of each interrupt event when CPU is not fast enough to handle every interrupt individually. Thus the invention improves the performance of networking process by reducing number of interrupts.

It is another object of the present invention to provide a method of handling an interrupt coalescing scheme for high throughput TCP offload engine. The method searches the interrupt event descriptor in the interrupt queue header for fast efficiently throughput of data networking.

It is another object of the present invention to provide a method of handling an interrupt coalescing scheme for high throughput TCP offload engine. TCP offload engine saves information in interrupt event descriptors and the software may process multiple interrupt queue descriptors asynchronously within one interrupt context.

Accordingly, one embodiment of the present invention is to provide an interrupt coalescing scheme for high throughput TCP offload engine, which includes: at least one interrupt descriptor queue receiving and storing a plurality of interrupt events from a TCP offload engine, then interrupt events executed by a software, wherein the interrupt descriptor queue comprising: a plurality of interrupt event descriptors storing runtime information of interrupt events copied from a plurality of TCP queue's headers in the TCP offload engine; and an interrupt queue header containing and managing a plurality of event descriptor pointers for queuing, wherein event descriptor pointers point to interrupt event descriptors.

In addition, a method of handling interrupts in an interrupt coalescing scheme includes: a TCP offload engine copying a TCP connection information and a TCP queue's header information to an interrupt event descriptor in an interrupt descriptor queue; a descriptor write pointer in an interrupt queue header is incremented to indicate a new interrupt event descriptor has been added; and a software receiving an interrupt signal and reading at least one interrupt event descriptor in the interrupt descriptor queue.

Other advantages of the present invention will become apparent from the following description taken in conjunction with the accompanying drawings wherein are set forth, by way of illustration and example, certain embodiments of the present invention.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is the block diagram of the interrupt coalescing scheme for high throughput TCP offload engine according to one embodiment of the present invention;

FIG. 2 is the data flow diagram in the interrupt coalescing scheme according to one embodiment of the present invention;

FIG. 3 is the frame of the interrupt queue header and interrupt event descriptor according to the embodiment of the present invention; and

FIG. 4 is the flow chart of handling interrupts in an interrupt coalescing scheme according to one embodiment of the present invention.

### DESCRIPTION OF THE PREFERRED EMBODIMENT

The present invention provides an interrupt coalescing scheme for high throughput TCP offload engine (TOE).

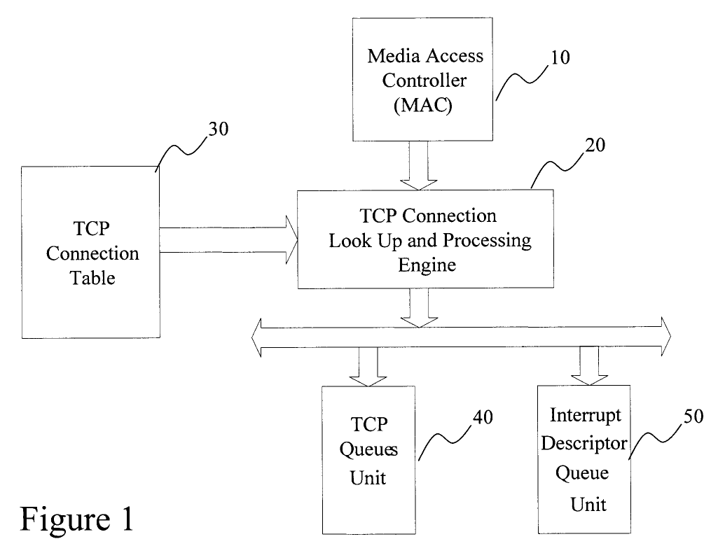

FIG. 1 shows the block diagram of the interrupt coalescing scheme for high throughput TCP offload engine according to one embodiment of the present invention. The Media Access Control (MAC) 10 provides addressing and channel access control mechanisms that makes it possible for several terminals or network nodes to communicate within a multipoint network, typically a local area network (LAN) or metropolitan area network (MAN). A TCP Connection Look Up and Processing Engine 20 receives packets from the MAC 10 and offloads processing of the entire TCP/IP stack from software running on a general-purpose CPU. A TCP Connection Table 30 resides in an external memory is accessed by the TCP Connection Look Up and Processing Engine 20. TCP Queues Unit 40 store TCP queues and send the TCP quesues to the Interrupt Descriptor Queue Unit 50, wherein the software will process multiple interrupt events within one interrupt context.

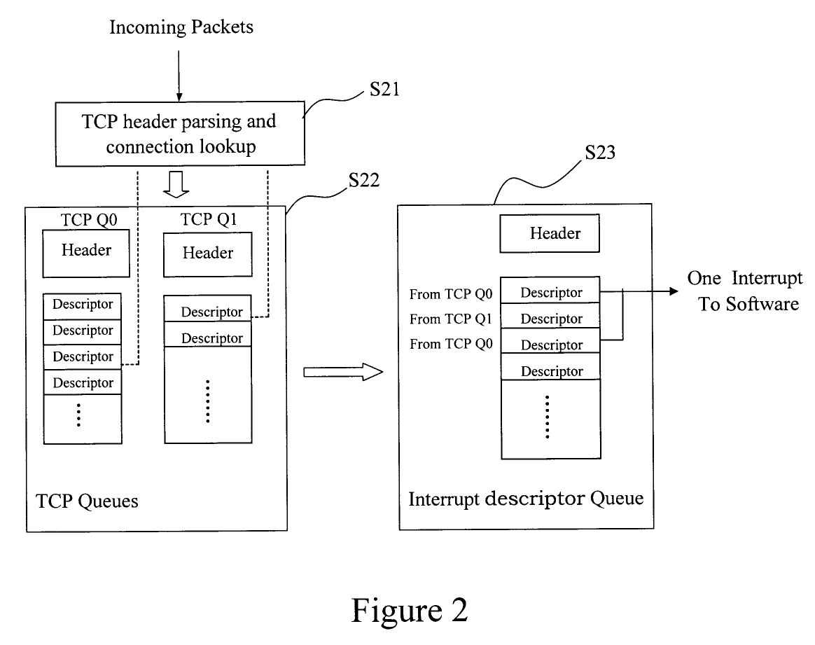

The Interrupt Descriptor Queue Unit 50 is designed to offload host TCP processing. Referring FIG. 2 is a data flow diagram in the interrupt coalescing scheme according to one embodiment of the present invention. In the state S21, incoming packet's header is parsed and look up for connection table in TCP Connection Look Up and Processing Engine 20, then the TCP frame is stored in any one of TCP Queues in the state S22, TCP Q0 or TCP Q1. In state S23, the descriptors in TCP Queues are transferred to the Interrupt descriptor Queue for waiting an interrupt trigger to software.

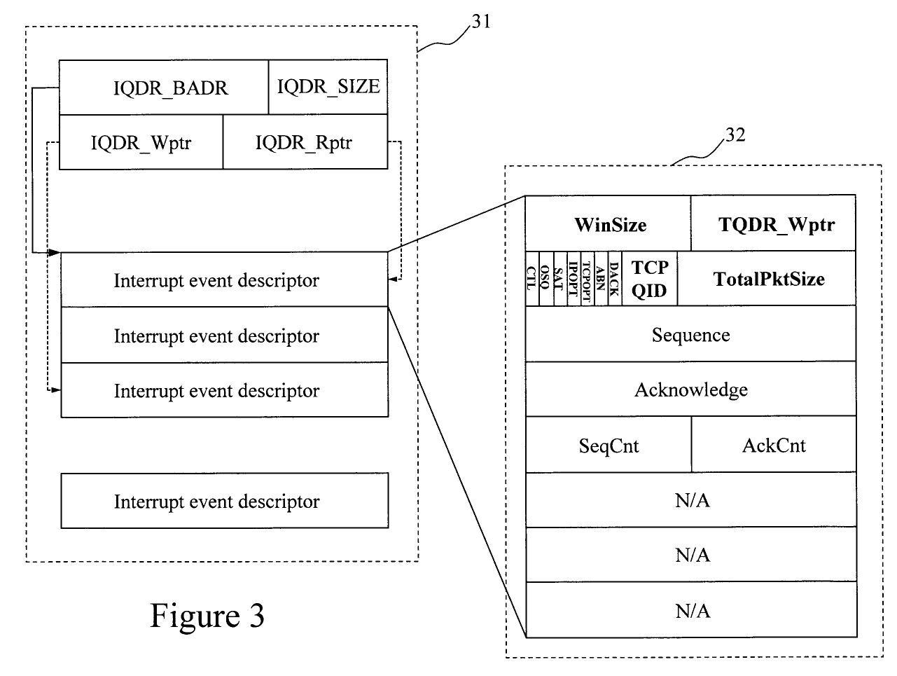

Conventionally, in state S22, the TCP queue header stores the runtime information of this TCP connection and it could be updated before processed by software, which is executed by processing unit. Therefore, an interrupt descriptor queue scheme for high speed TCP receiving data assembly is designed. An interrupt descriptor queue is used wherein the interrupt queue header and interrupt event descriptor format are illustrated as FIG. 3. Before interrupt is issued, fields in interrupt queue header 31 will be copied to as interrupt event descriptor 32. Software can process TCP queue by reading information saved in the interrupt event descriptor 32, which defines specific interrupt event descriptor format designed for the TCP offload engine's interrupt process.

The interrupt queue header 31 includes: IQDR_BADR (28 bits) presenting an interrupt queue descriptor ring base address, 16 bytes aligned and software written; IQDR_SIZE (4 bits) presenting an interrupt queue descriptor ring size, calculated as 2̂(IODR_SIZE+3), and software written; IQDR_Wptr presenting an interrupt queue descriptor ring write pointer and software written; IQDR_Rptr presenting an Interrupt queue descriptor ring read pointer and software written; and several interrupt event descriptor pointers.

In the interrupt queue header 31, interrupt queue read pointer points to an interrupt descriptor whose frame includes: a WinSize (16 bits) presenting the WinSize from TCP queue header; a TQDR_Wptr (16 bits) presenting TQDR_Wptr from TCP queue header; CTL (1 bit) presenting CTL bit from TCP queue header; OSQ (1 bit) presenting OSQ bit from TCP queue header; SAT (1 bit) presenting SAT bit from TCP queue header; IPOPT (1 bit) presenting IPOPT bit from TCP queue header; ABN (1 bit) presenting ABN bit form TCP queue header; DACK (1 bit) presenting DACK bit from TCP queue header; TCPQID (8 bit) presenting TCP queue id that this interrupt event is about; TotalPktSize (17 bits) presenting TotalPktSize from TCP queue header; Sequence (32 bits) presenting Sequence from TCP queue header; Acknowledge (32 bits) presenting Acknowledge from TCP queue header; SeqCnt (16 bits) presenting SeqCnt from TCP queue header; and AckCnt (16 bits) presenting AckCnt from TCP queue header.

Accordingly, Whether a TCP packet matches a TCP queue or not is by comparing source IP address, destination IP address, source TCP port number and destination TCP port number. When a received TCP packet matches, it will be appended to the end of TCP queue, and TCP queue header will be updated accordingly. A variety of circumstances are defined when interrupts should be triggered and related TCP queue header information will be copied to interrupt event descriptor.

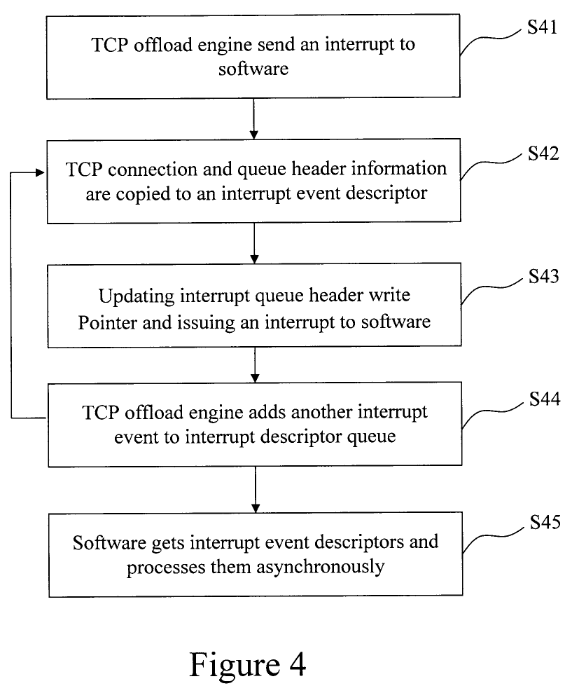

Accordingly, the present invention provides a method of handling interrupt event descriptor coalescing scheme for high throughput TCP offload engine. Referring to FIG. 4, which is the flow chart of handling interrupts in an interrupt coalescing scheme according to one embodiment of the present invention, the method includes: step S41 an interrupt is triggered from a connecting interface, the TCP offload engine needs to send an interrupt to software. The TCP offload engine copies a TCP connection information and a TCP queue header information to an interrupt event descriptor for each interrupt; step S42 queuing the interrupt event descriptor, TCP connection and queue header information are copied to an interrupt event descriptor. The write pointer in interrupt queue header is incremented to indicate a new interrupt event descriptor has been added; step S43 reading the first interrupt even descriptor in the interrupt queue header, and a write pointer in interrupt queue header is updated and an interrupt is issued to software; step S44 processing the information in the interrupt event descriptor. The TCP offload engine may add another interrupt event to interrupt descriptor queue, and update the write pointer. The software processes interrupts by reading interrupt event descriptors in interrupt descriptor queue. The read pointer in interrupt queue header is updated by software as interrupt event descriptors are handled. Therefore, software could process multiple interrupt event descriptors within one interrupt context; step S45 reading new first interrupt even descriptor in the interrupt queue header, Software receives interrupt and processes interrupt event descriptors in interrupt descriptor queue, and update read pointer in interrupt queue header. Therefore, the TCP offload engine could continuously adding interrupt events to interrupt queue, regardless software has processed the last interrupt or not.

In STEP 41 triggering the interrupt has following events;
1. When SYN, FIN, PSH, URG, or RST flag is detected in incoming TCP packet, an interrupt is triggered and CTL bit is on.
2. When the sequence number of incoming TCP packet is not as expected, an interrupt is triggered, and OSQ bit is on.
3. When the incoming TCP packet is found as duplicated ACK, an interrupt is triggered and DACK bit is set.
4. When the Acknowledge number of incoming TCP packet is smaller than Acknowledge number saved in interrupt descriptor queue header, an interrupt is triggered and ABN bit is set.
5. When the change of sequence number is larger than SeqThreshold, an interrupt is triggered.
6. When the change of acknowledge number is larger than AckThreshold, an interrupt is triggered.
7. When total TCP payload size of accumulated frames is larger than MaxPktSize, an interrupt is triggered.

By providing above information of TCP queue and connection status, the software is capable to handle multiple TCP interrupt events saved in interrupt event descriptors without missing any interrupt event when the CPU cannot catch up the speed of the data transmitting from high speed networking system. With this interrupt coalescing mechanism, the host system can reach very high TCP transport throughput.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. An interrupt coalescing scheme for high throughput TCP offload engine, comprising:
at least one interrupt descriptor queue, receiving and storing a plurality of interrupt events from a TCP offload engine, then said interrupt events executed by a software, wherein said interrupt descriptor queue comprising:
a plurality of interrupt event descriptors, storing runtime information of said interrupt events copied from a plurality of TCP queue's headers in said TCP offload engine; and
an interrupt queue header, containing and managing a plurality of event descriptor pointers for queuing, wherein said event descriptor pointers point to said interrupt event descriptors.

2. The interrupt coalescing scheme for high throughput TCP offload engine according to claim 1, wherein each said interrupt event descriptor is a frame copying a plurality of TCP queue header's field.

3. The interrupt coalescing scheme for high throughput TCP offload engine according to claim 2, wherein said frame comprises a WinSize field, a TQDR_Wptr field, a CTL field, an OSQ field, a SAT field, a IPOPT field, an ABN field, a DACK field, a TotalPktSize field, a Sequence field, an Acknowledge field, a SeqCnt field, and an AckCnt field.

4. The interrupt coalescing scheme for high throughput TCP offload engine according to claim 1, wherein each said interrupt event descriptor further comprises a TCPQID field presenting TCP queue id of said interrupt event descriptor.

5. The interrupt coalescing scheme for high throughput TCP offload engine according to claim 1, wherein said interrupt queue header further comprises a descriptor buffer base address, a plurality of descriptor read and descriptor write pointers.

6. A method of handling interrupts in an interrupt coalescing scheme, comprising:
a TCP offload engine copying a TCP connection information and a TCP queue's header information to an interrupt event descriptor in an interrupt descriptor queue;
a descriptor write pointer in an interrupt queue header is incremented to indicate a new interrupt event descriptor has been added; and
a software receiving an interrupt signal and reading at least one interrupt event descriptor in said interrupt descriptor queue.

7. The method of handling interrupts in an interrupt coalescing scheme according to claim 6, wherein said interrupt signal is sent by said TCP offload engine.

8. The method of handling interrupts in an interrupt coalescing scheme according to claim 6, wherein said TCP offload engine continuously adding interrupt event descriptors to said interrupt descriptor queue, regardless a software's interrupt.
